(19) United States
(12) Patent Application Publication
(10) Pub. No.: US 2012/0233067 A1
(43) Pub. Date: Sep. 13, 2012

(54) SYSTEM AND METHOD FOR PROVIDING AN INTERACTIVE REMOTE CONTROLLED JUKEBOX

(75) Inventors: Gerasolo Francis Matthew, Flemington, NJ (US); Michael Francis Mackintosh, II, Belle Mead, NJ (US)

(73) Assignee: PROTEUS STUDIOS, INC., Flemington, NJ (US)

(21) Appl. No.: 13/042,514

(22) Filed: Mar. 8, 2011

(51) Int. Cl. G06Q 40/00; G06F 15/16

(52) U.S. Cl. 705/40; 709/219; 709/203; 705/44

(57) ABSTRACT

The present invention generally relates to interactive remote controlled jukebox systems. Specifically, this invention relates to a system and method for managing, controlling, delivering and playing audio or other multimedia on a jukebox, jukebox-like apparatus or an electronic device/computing device (e.g., tablet computer, mobile phone, network enabled TV, set-top box, audio/video receiver) via a remote control. The remote control may be comprised of a computing device (e.g., smartphone, PDA, tablet PC, laptop, cellular phone, desktop PC).

### FIELD OF THE INVENTION

The present invention generally relates to interactive remote controlled jukebox systems. Specifically, this invention relates to a system and method for managing, controlling, delivering and playing audio or other multimedia on a jukebox, jukebox-like apparatus or an electronic device/computing device (e.g., tablet computer, mobile phone, network enabled TV, set-top box, audio/video receiver) via a remote control. The remote control may be comprised of a computing device (e.g., smartphone, PDA, tablet PC, laptop, cellular phone, desktop PC).

### BACKGROUND OF THE INVENTION

The use of jukeboxes and other devices to curate audio content to audiences at events has been available for decades. Bars, nightclubs, pool halls, restaurants and even individual residences have used these devices to allow the attendees of an event to queue songs that they enjoy, typically for a fee. In standard format, a user pays the associated fee for a number of songs that will be played in a first-in-first-out (FIFO) format. The first song entered is the first song played, then the second song and so on and so forth.

These jukebox systems have advanced and evolved over time, from the large apparatuses in the corner of a venue to computerized systems with touch screen displays capable of playing content in digital format (e.g., MP3, WAV, MIDI). Some have even added support for playback formats other than FIFO, including shuffle play and random play.

However, all of these systems still require a user to interact with a terminal located on the system itself to enter payment and make song selections. This requires users to wait in line to enter songs, have appropriate payment methods (e.g., coins, tokens, paper bills) and wait for their songs to play in a particular order. Additionally, if a user is unfamiliar with a venue, the user may not even know the jukebox system exists.

Additionally, most jukebox systems currently used only allow the playback of songs that are stored locally on the system. Since Jukeboxes are infrequently updated, this limits the users of the jukebox to an ever aging catalog of content. Some jukeboxes are capable of receiving songs over the internet, however these systems charge enormous premiums for content delivery and do not handle content validation, licensing or other issues related to the delivery and playback of songs.

Jukebox systems currently in use also lack the ability to rank and rate the songs based on the tastes of the users at the venue. Currently, a user may select a song to play, but may not input their reviews of the chosen songs. Additionally, currently, users at a venue also lack the ability to rate/rank/review the songs chosen by others at the venue. At present, the most advanced usage/rating/ranking feature provided by jukeboxes is the ability for a user to view the most commonly played songs.

Therefore, there is a need in the art for a system and method for providing a jukebox that allows for remote content selection, remote content delivery, complex content selection features, and features that allow for the rating, ranking and/or reviewing of content. These and other features and advantages of the present invention will be explained and will become obvious to one skilled in the art through the summary of the invention that follows.

### SUMMARY OF THE INVENTION

The present invention provides a system and method for a jukebox and remote control device(e.g., portable media players, tablet computers, mobile phones, network enabled TVs, set-top boxes, audio/video receivers) that allow for content selection, remote content delivery, complex content selection features, immediate play functionality, queuing of content and features that allow for the rating ranking and reviewing of content. The system and method may be provided via one or more computing devices communicatively connected over one or more networks.

According to an embodiment of the present invention, the system is comprised of one or more host components, one or more server components and one or more client components. The one or more host components, one or more server components and one or more client components may be provided via one or more computing devices. In an exemplary embodiment, at least one host component and one server component is provided via a first computing device and a client component is provided via a second computing device. In a second exemplary embodiment of the present invention, a host component is provided via a first computing device, a server component is provided via one or more second computing device and one or more client components is provided via one or more third computing devices.

According to an embodiment of the present invention, a host component may provide functionality for storing, controlling, managing, distributing, receiving and playing content. Additionally, the host component may also provide functionality for receiving content play requests, receiving payments and verifying client components. The host component may also provide functionality for communicating, via one or more networks, one or more client components and/or one or more server components.

According to an embodiment of the present invention, a client component may provide functionality for communicating, via one or more networks, with one or more host components and one or more server components. Additionally, a client component may provide functionality for queuing content, placing payments, validating a user's identity, validating a user's location, receiving invoices, receiving advertisements and managing a host component and/or server component.

According to an embodiment of the present invention, a server component may provide functionality for communicating via one or more networks, with one or more hosts components and one or more client components. Additionally, a server component may provide functionality for delivering content to a client component or host component, validating a host component, validating a user component, validating a user's identity, validating a user's location, delivering advertisements to a host component, delivering advertisements to a client component, receiving payments, validating content licenses and streaming content.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a schematic overview of a network system for carrying out this invention in accordance with an embodiment of the present invention;

FIG. 2 is a schematic of an exemplary embodiment showing connectivity between the various components of a host component;

FIG. 3 is a schematic of an exemplary embodiment showing connectivity between the various components of a server component;

FIG. 4 is a schematic of an exemplary embodiment showing connectivity between the various components of a client component; and

FIG. 5 is a process flow of an exemplary embodiment of a method in accordance with the present invention.

### DETAILED SPECIFICATION

The present invention generally relates to interactive remote controlled jukebox systems. Specifically, this invention relates to a system and method for managing, controlling, delivering and playing audio or other multimedia on a jukebox, jukebox-like apparatus or an electronic device/computing device (e.g., tablet computer, mobile phone, network enabled TV, set-top box, audio/video receiver) via a remote control. The remote control may be comprised of a computing device (e.g., smartphone, PDA, tablet PC, laptop, cellular phone, desktop PC).

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users and components of the system across local area networks (LANs) (e.g., office networks, home networks, Bluetooth networks), wide area networks (WANs) (e.g., the Internet) and/or cellular/mobile networks (e.g., CDMA, EvDO, HSPA, HSPA+, LTE, WiMax). In accordance with this embodiment, the system may be comprised of numerous computing devices communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data and transactions offline that will be consumed by the system when the user is later connected to a network.

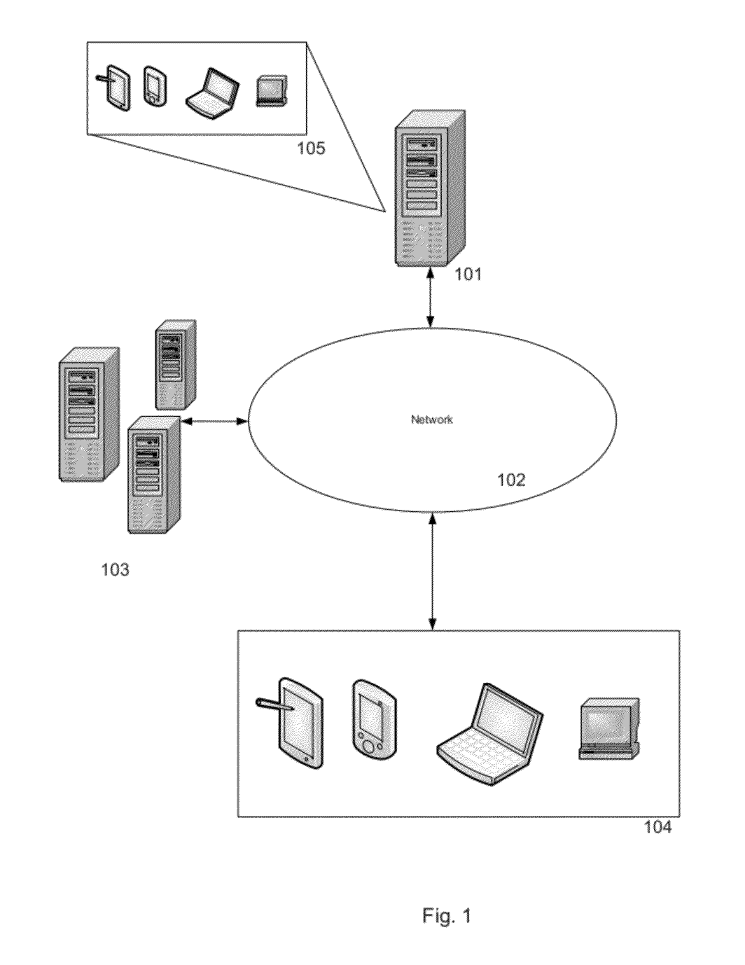

Referring to FIG. 1, a schematic overview of an exemplary system in accordance with an embodiment of the present invention is shown. The system is comprised of one or more server components 103 for electronically storing and processing data and transactions used by the system and one or more host components 101 for electronically storing and processing data and transactions used by the system. Applications in the one or more server components 103 and one or more host components 101 may retrieve and manipulate information in storage devices and exchange information through a network 102 (e.g., the Internet, Bluetooth network, Wi-Fi network, LAN, WAN). While FIG. 1 shows host component 101 as a server, it should be understood that host component 101 may be comprised of any type of computing device 105, as the term is herein described.

According to an exemplary embodiment, as shown in FIG. 1, exchange of information through the network 102 or other network may occur through one or more computing devices connected to the network. One of ordinary skill in the art would appreciate that there are numerous ways the one or more computing devices may connect to network 102 for the exchange of information, and embodiments of the present invention are contemplated for use with any method for connecting to networks for the purpose of exchanging information.

One or more users with computing devices comprised of client components 104 may connect to the one or more server components 103 and one or more host components 101 via network 102 or other network(s) in numerous ways. For instance, a user may connect to the system i) through a computing device comprised of a client component 104 directly connected to the network 102, ii) through a computing device comprised of a client component 104 connected to the network 102 through a routing device, iii) through a computing device comprised of a client component 104 connected to a wireless access point or iv) through a computing device comprised of a client component 104 via a wireless connection (e.g., CDMA, GMS, 3G, 4G) to the network 102. One of ordinary skill in the art would appreciate that there are numerous ways that a member may connect to server component 103 and host component 101 via network 102 or other network, and embodiments of the present invention are contemplated for use with any method for connecting to the one or more sever components 103 and one or more host components 101 via network 102 or other network.

According to an embodiment of the present invention, an individual or organization may signup to become user of the system herein provided. In an exemplary embodiment, an individual or organization would go through a registration process, whereby they would provide identifying information to be stored in one or more server components 103, one or more host components 101 or any combination thereof. This identifying information may be used, for instance, to identify the user, secure the user's login or process financial transactions. One of ordinary skill in the art would appreciate there are numerous ways to provide and manage registration processes, and embodiments of the present invention are contemplated for use with any method for providing and managing registration processes.

In an exemplary embodiment of the present invention, the one or more host components 101 would be located at a particular venue where multimedia content will be consumed. Possible venues include, but are not limited to, bars, restaurants, pool halls, concert halls, residential dwellings, cafes, retail stores, malls, vehicles, watercraft, aircraft, waiting rooms or any other place where it would be desirable to have a system for managing, controlling and playing multimedia content. One of ordinary skill in the art would appreciate there are numerous venues that would be appropriate, and embodiments of the present invention are contemplated for use with any venue.

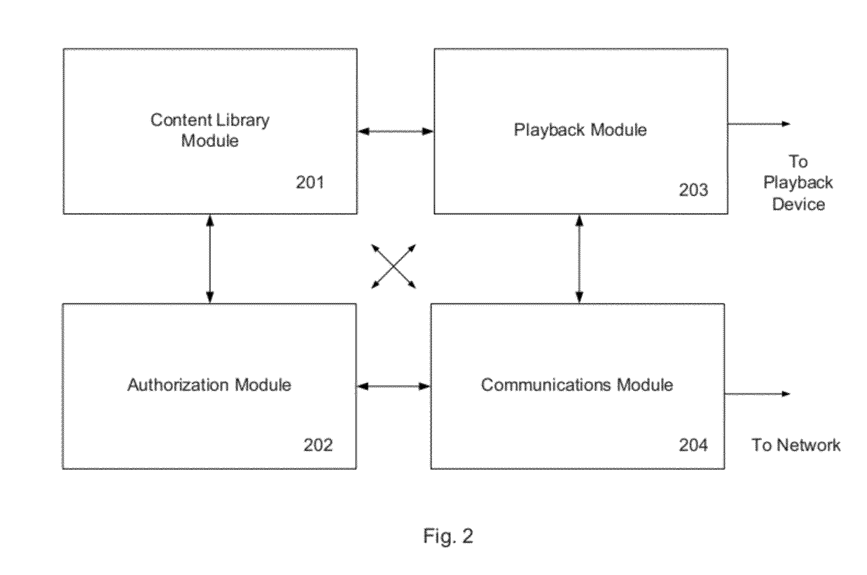

Turning now to FIG. 2, The host component 101 may be comprised of one or more of a content library module 201, authorization module 202, playback module 203 and communications module 204.

According to an embodiment of the present invention, the content library module 201 is responsible for storing, managing, authorizing multimedia content as well as providing the multimedia content to the playback module when required. Multimedia content may be stored locally on the computing device of the host component 101.

Alternatively or in addition to the previous method, the multimedia content may be stored remotely at the server component 103, the computing device of the server component 103, the client component 104, the computing device of the client component 104, or any combination thereof. In this manner, multimedia content may be provided from a variety of sources, allowing content to be added or modified in real-time or near real-time. Advantageously, in this manner, the multimedia content may be managed in such a way that the multimedia content is always current or applicable for a given audience.

According to an embodiment of the present invention, the content library module 201 may validate licenses for the multimedia content. This can be accomplished locally at the content library module 201 or through the server component 103. Validation of multimedia content is especially desirable when the content is provided from a remote source, such as from the server component 103 or client component 104. Validation of multimedia content may include checking the multimedia content for appropriate licenses and metadata, checking the multimedia content for viruses or other malware, checking the content for applicability to the particular venue or event, or any combination thereof.

Referring to checking multimedia content for licenses and metadata, when multimedia content is to be played at a venue or event, it is important to know that the venue owner or event coordinator has the appropriate licenses to playback the multimedia content to the audience. Licenses may include, but are not limited to, ASCAP, BMI, SESAC, MPLC, THQ, Play4Sure and FairPlay. By validating multimedia content, a venue owner or event coordinator may confirm that they have the appropriate rights required to playback the multimedia content without fear of reprisal, legal or otherwise. Additionally, validating the metadata can confirm that the multimedia content has not been altered in any way from its original content or form.

Referring to checking the multimedia content for viruses or other malware, when multimedia content is provided to the host component 101, it is important to ensure that the provided multimedia content is not attempting to infect the host component 101 or the computing device comprised of the host component 101. Since the systems and method herein described are allowing for users to access remote computing devices with potentially sensitive information contained within, it is important to provide robust protections against viruses, malware, spyware and other undesirable content. One of ordinary skill in the art would appreciate that there are numerous ways to scan for, identify, block and remove undesirable content, and embodiments of the present invention are contemplated for use with any method of scanning for, identifying, blocking and removing undesirable content.

Referring to checking the multimedia content for applicability to the particular venue or event, the host component 101 may be configured to only allow certain types or genres of multimedia content, depending on the particular venue or event. In this manner, a venue or event may prevent the playback of multimedia content that would be inappropriate or undesirable for the audience. For instance, a country music bar may wish to prevent rap, dance and pop music from being played, so the host component 101 would be configured to either prevent these types of music or specifically only allow country music. In another example, a bar with a video screen may only wish to play multimedia content with a video component, and therefore configure the host component 101 to prevent any content that is not comprised of video content.

According to an embodiment of the present invention, the authorization module 202 may provide functionality to authorize one or more transactions. Types of transactions capable of being authorized by the authorization module 202 include, but are not limited to, credit card transactions, ach transactions, location verification transactions, user verification transactions.

Referring to credit card transactions and ach transactions, the authorization component 202 may be configured to receive payment information from a user and process and validate the information in regards to one or more transaction types. Transaction types include, but are not limited to, payments related to request for standard playback of one or more multimedia content selections, payments related to priority playback of one or more multimedia content selections and payments related to advertising.

Referring to location verification transactions, the authorization component 202 may be utilized to confirm the location of one or more users. This allows venues to prevent users who are not located within a specific distance of the venue from utilizing the systems and methods herein described. Advantageously, venues can limit use of their jukebox systems to those users who are actually in attendance of the venue or event at a particular time. This may help prevent misuse of the jukebox system in general.

Additionally, recording of the location validation of the user may also provide valuable verification as it relates to payment transactions. By verifying that a particular user was at the venue or event at the time a payment transaction is conducted, fraudulent transactions may be prevented or identified.

Referring to user verification transactions, the authorization component 202 may be configured to confirm the identity of one or more users. For instance, the authorization component 202 may be configured to receive one or more security related data points that could confirm a user's identity. Security related data points include, but are not limited to, user name, password, encryption keys, IPv4 addresses, IPv6 addresses and biometric information. Confirming the identity of the users of the present Jukebox system herein described is advantageous in that it helps prevent misuse of the system and may allow for monitoring and other metrics related to particular users. For instance, certain Jukebox systems may only allow certain registered and approved users to commit one or more of multimedia content playback requests, payment transactions, system management requests, uploading of multimedia content, downloading of multimedia content, uploading of advertising content and user management requests.

According the an embodiment of the present invention, the playback module 203 may provide functionality to playback multimedia content or deliver playable multimedia content or advertising content to one or more playback devices. Playback devices include, but are not limited to, computing devices, PA systems, video screens, home theater systems, lighting systems, network enabled TVs, portable media players, audio/visual receivers, set-top boxes and speaker systems. One of ordinary skill in the art would appreciate that there are numerous playback devices that could be used with embodiments of the present invention, and embodiments of the present invention are contemplated for use with any type of playback device.

According to an embodiment of the present invention, playback devices may also include the computing device used by a user to connect to the jukebox system herein described. Additionally, the computing device used by a user may also be provided advertising content that is played back on their computing device when the user performs one or more transactions with the system.

According to an embodiment of the present invention, the communications module 203 may provide functionality to communicate data between one or more computing devices. The communications module is communicatively connected to one or more of a content library module 201, an authorization module 202 and a playback module 203 and is configured to manage the inbound and outbound data communication between the respective modules and one or more networks 102.

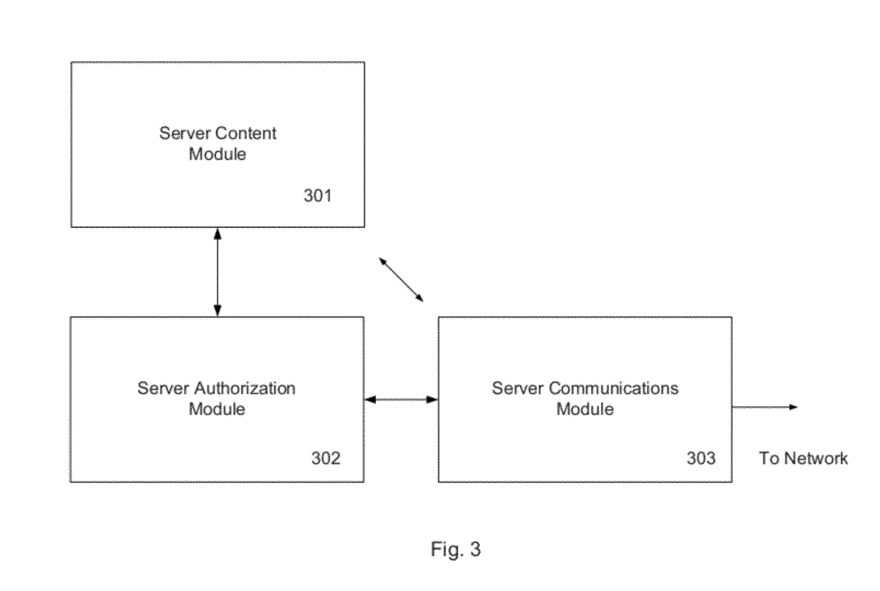

Turning now to FIG. 3, The server component 103 may be comprised of one or more of a server content module 301, Server authorization module 302 and server communications module 303.

According to an embodiment of the present invention, the server content module 301 is responsible for storing, managing, providing and authorizing multimedia content. Many of the features of the server content module 301 are similar to the features of the content library module 201 located on the host component 101. The server content module 301 may be configured to validate multimedia content, check the multimedia content for appropriate licenses and metadata, check the multimedia content for viruses or other malware, check the content for applicability to the particular venue or event, receive new content from a verified source, receive new content from a non-verified source, transmit content to a client component 104, transmit content to a host component 101, or any combination thereof

One advantage of using a separate server component 103 with a server content module 301 is that a single server component 103 may be shared between a plurality of host components 101 allowing for any update or verification occurring on the server component 103 to affect a content library module 201 on each of the plurality of host components 101. Advantageously, global server components 103 may be used to support numerous unrelated venues, events and users. Alternatively, proprietary server components 103 may be used to support numerous related venues, events and users (e.g., the venues, events and users related to a chain of restaurants).

According to an embodiment of the present invention, the server authorization module 302 is responsible for authorizing one or more transactions. These transactions may be of the types previously discussed. Advantageously, a server component 103 with a server authorization module 302 may assist one or more host applications by handling some or all of the transaction requests. In this manner, the server component 103 with a server authorization module 302 may be utilized to distribute or offload the transaction process and provide levels of security that may not be applicable on the host component 101.

Additionally, since server components 103 may be shared between multiple organizations, venues, events and users, a server component 103 with a server authorization module 302 may store transaction information related to one or more organizations, venues, events or users which may allow for streamlining of transactions. For instance, a user's credit card information may be stored at a server authorization module 302 on a server component 103 allowing for the user to simply select a transaction type and apply the stored credit card information to the transaction, reducing the overall time it takes to create and process a transaction.

According to an embodiment of the present invention, the server communications module 303 provides functionality to communicate data between one or more computing devices. The server communications module 303 is communicatively connected to one or more of a server content module 301 and a server authorization module 302. The server communications module 303 may manage inbound and outbound data communication between the respective modules and one or more networks 102.

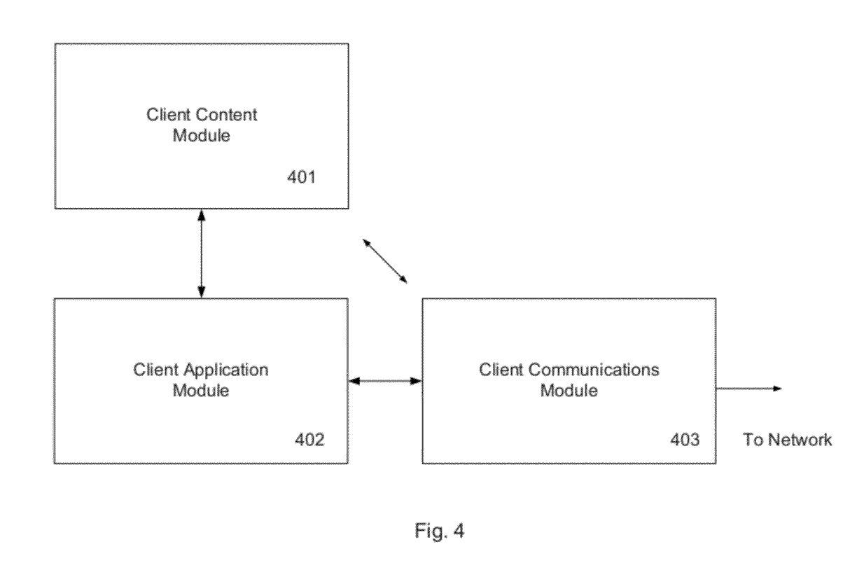

Turning now to FIG. 4, The client component 104 may be comprised of one or more of a client content module 401, client application module 402 and client communications module 403.

According to an embodiment of the present invention, the client content module 401 may be responsible for storing, managing and providing multimedia content. The client content module 401 is an optional module and is not required in many variations of the present invention. Many of the features of the client content module 401 are similar to the features of the content library module 201 located on the host component 101. However, the client content module 401 may not be provided the functionality to validate content as the client components 104 a generally considered non-trusted devices. Non-trusted refers to the fact that the client components 104 may belong to one or more users that have limited privileges with respect to the jukebox system. Limited privileges may include, for instance, the privileges required to submit playback requests, but not management requests.

Optionally, the systems and method herein described may provide functionality whereby a non-trusted client component 104 becomes a trusted client component 104via one or more authorization and/or registration methods. For instance, a client component 104 may be provided with a special encrypted certification that the host component 101 or server component 103 recognize as providing trusted status to the client component 104.

The client content module 401 may also be configured to transmit multimedia content or advertising content to a host component 101. In this manner, a user may provide multimedia content or advertising content to the system for use and playback at a particular venue or event. For instance, a user may have multimedia content on his smartphone and wish to have that multimedia content played at the bar he is currently at. If the bar does not already have the particular multimedia content available via its server content module 301 or its content library module 201, the user may be allowed to upload the multimedia content to either the server component 103 or the host component 101. After uploading the content, the system may validate the content as previously described and playback the content. The system may require that the user submit one or more payment transactions related to the upload, validation and playback of the multimedia content.

According to an embodiment of the present invention, in addition to multimedia content, the system may allow clients to upload advertising content to host component 101 or server component 103. In this manner, a user could be provided with a method for uploading advertising information directly to a venue or event that would be directly relevant to the user's business or intended audience. Advantageously, users could, ad hoc or through planned methods, take advantage of characteristics (e.g., location, venue type, event type, clientele type, time of day) of particular venues or events to propagate very specific advertising campaigns. Advertising content may be delivered via the playback module 203 of the host component 101 or directly to the client component 104 for playback on the user's computing device.

The previously discussed method also has the advantage of allowing advertisers to choose not to spend money on venues or events that do not turn out as anticipated. For instance, if a venue or event anticipates a turnout of 1,000 individuals and bases advertising rates on that number, but only 200 individuals show up, the advertiser may decide not to advertise at that particular venue or event. Additionally, venues or events may set advertising rates based on the actual number of individuals in attendance at a particular time.

According to an embodiment of the present invention, the client application module 402 is responsible for processing interactions between the client component 104 and the host component 101 and the server component 103. Interactions include, but are not limited to, submitting payment transactions, submitting playback requests, submitting content requests, submitting advertising requests, management requests, receiving lists of available multimedia content from a server component 103, receiving lists of available multimedia content from a host component 101.

According to an embodiment of the present invention, the client communications module 403 provides functionality to communicate data between one or more computing devices. The client communications module 403 is communicatively connected to one or more of a client content module 401 and a client application module 402. The client communications module 403 may manage inbound and outbound data communication between the respective modules and one or more networks 102.

Applications of the Systems and Methods Herein Described.

According to an embodiment of the present invention, one of the main functionalities of the system herein described is the providing the ability for one or more client components 104 the ability to receive information from and provide inputs to a host component 101. Information to be received from a host component 101 include one or more of content lists, advertising content, multimedia content, payment information, venue information, event information or any combination thereof. Inputs include, but are not limited to, add multimedia content selection to a queue of multimedia content to be played at a venue or event and rate/rank multimedia content played at a venue or event. By allowing users to submit multimedia playback requests and ratings through the use of a client component 104, the jukebox system herein described is able to automate and improve jukebox systems.

Submission and/or selection of multimedia content for playback may be free or for cost. Costs may be defined by the owners or operators of the venue or event. Costs are not required to be fixed either. For instance, costs associated with submission/selection of multimedia content may scale in response to the number of requests, the number of patrons at the venue/event, the time of day or any combination thereof. This allows venues or events to maximize their potential profit from a jukebox system.

According to an embodiment of the present invention, a venue or event may allow for different levels of queuing of multimedia content for different costs. For instance, a venue or event may allow a user to select multimedia content for playback in a FIFO format for a first cost, and allow a user to select multimedia content for priority playback or immediate playback for a second cost greater than the first cost.

Additionally, a venue or event may also allow for the insertion/use of advertising content. In this manner, a venue or event may configure the systems herein described to play one or more advertisements in between the playback of multimedia content. Optionally, the advertising content may also be delivered for playback on a computing device of a user. For instance, when a user wishes to submit a request for the playback of multimedia content, the user will be required to watch an advertisement first.

According to an embodiment of the present invention, advertising content may include advertisements specific to the venue or event. Venue or event specific advertisements include, but are not limited to, specials, menus and upcoming events. In this manner, a venue or event could provide customers with directed advertising that may result in increased sales at the particular venue or event.

According to an embodiment of the present invention, a unique rating/ranking system is also provided. A venue or event may allow for specific ratings/rankings of multimedia content. For instance, a venue or event may allow for the rating of multimedia content in relation to the specific event or date at a venue. In this manner, attendees of an event or venue at a specific date may rate the multimedia content in relation to the event. Since the rating of multimedia content may vary depending on the attendees of any specific event, storing and providing event specific ratings is particularly useful.

According to an embodiment of the present invention, the system herein defined may allow for the ratings of content to be stored and applied in future uses. The ratings can be viewed as an aggregate across all types of events/venues or can be summarized on a per event/venue/geographical basis. Ratings may be represented, for instance, at a global, country, state, urban area basis. Ratings can be tracked and represented, for instance, by type of venue (i.e. Pool Hall, Country themed bar, night club, residential, college bar, etc.). Ratings can also be tracked, for example, by type of event (i.e. poker night, house warming party, BBQ, dance night, cocktail hour, dinner party). Information about an event can then be used to track and display popular songs by provided parameters. Additionally, suggestions may be made for additional songs to play or purchase using these types of provided parameters. In the event of no selections currently being made by a client device, content selection can be automated based of the ratings system for most likely songs in a library that fit in with the other music selected or event type/venue/geographic location.

### Exemplary Embodiment

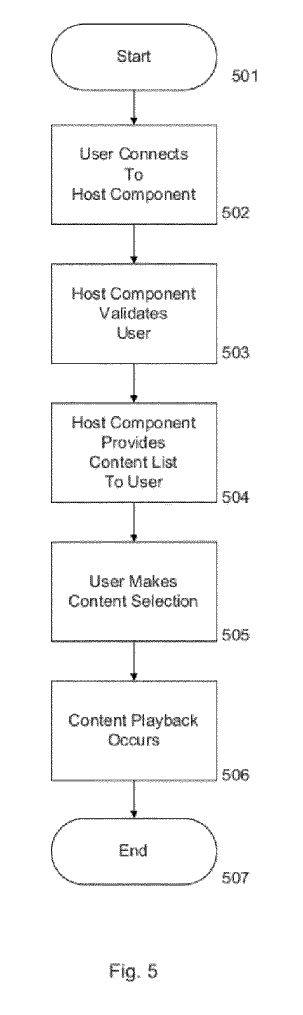

Turning now to FIG. 5, an exemplary method in accordance with an embodiment of the present invention is described. The method starts at step 501 and begins with a user entering a venue or event which has a jukebox system in accordance with the system and methods herein described.

At step 502, the user connects his computing device with a client component 104, via a network 102, to a host component 101. This may be initiated by, for instance, the launching of a software application on a smartphone which searches for events or venues currently available within the user's geographic location as determined by one or more location determination service (e.g., GPS, signal triangulation, wireless network identification).

At step 503, the host component 101 validates the user and provides a set of functions available to the user based on his validation. For instance, if the user is validated as a patron at a venue or event, he may have functionality limited to submitting playback and rating requests. If the user is validated as a manager of the venue or event, functionality may also be provided allow for management of playback, advertising content, costs of playback submissions, review or ratings and usage reporting.

At step 504, the host component 101 provides a listing of available multimedia content to the client component 104 of the user's computing device. This listing contains some or all of the multimedia content available for playback at the host component 101.

At step 505, the user selects, via the client component 104 on the user's computing device, one or more multimedia content for playback at the host component 101. This selection is sent over the network 102 to the host component 101 and any necessary validation or payment is also transacted at this time. Once the validation and/or payment is complete, the selection is added to the appropriate place in the playback queue.

At step 506, the multimedia content selected by the user is played via a playback device. Prior to, during or after the playback, the user and other users may also choose to rate the multimedia content. These rating may be stored for use at a later time in relation to global ratings, user ratings or event/venue specific ratings.

At step 507, the method ends. The previous steps are merely for example purposes. The steps are not required to be executed in this order, and one of ordinary skill in the art would appreciate that these steps could be executed in a variety of different manners as well as having two or more of the steps executing simultaneously.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A method for providing a remote controlled jukebox, said method comprising:
receiving, at an host component, a request for access from a first user;
verifying, at said host component, said request for access from said first user,
providing, from said host component, a content list to said first user;
receiving, at said host component, a content selection from said first user,
wherein said content selection is identifies one or more content for playback,
wherein each of said one or more content is identified in said content list;
submitting, at said host component, said content selection into a playback queue,
wherein said playback queue is comprised of one or more queued content; and
communicating said one or more queued content, from said host component, to a playback device.

2. The method of claim 1, further comprising the steps of:
sending, from said host component, to said first user, a payment request;
wherein said payment request is related to said content selection from said first user; and
receiving, at said host component, payment information,
wherein said payment information is related to said payment request.

3. The method of claim 1, wherein said content selection is marked for priority playback.

4. The method of claim 3, wherein said content selection is submitted into a point other than an end of said playback queue.

5. The method of claim 1, wherein said one or more content for playback is comprised of multimedia content.

6. The method of claim 1, wherein said one or more content for playback is comprised of advertising content.

7. The method of claim 1, wherein said set of playback device is comprised of an audio source.

8. The method of claim 1, wherein said set of playback device is comprised of a video source.

9. the method of claim 1, further comprising the steps of:
receiving, at said host component, one or more ratings,
wherein said one or more ratings correspond to said one or more queued content; and
associating said one or more ratings with an event.

10. A system for providing a remote controlled jukebox, the system comprising:
a host component; and
one or more client components communicatively connected to said host component,
wherein said host component is configured to send a content list to said one or more client components,
wherein said host component is configured to receive content selections from said one or more client components,
wherein said host component is configured to enter said content selections into a playback queue,
wherein said host component is configured to communicate said playback queue to one or more playback devices.

11. The system of claim 10, wherein said content selection is comprised of one or more multimedia content.

12. The system of claim 10, wherein said host component is configured to validate said one or more client components.

13. The system of claim 10 further comprising a server component communicatively connected to said host component.

14. The system of claim 13, wherein said server component is configured to receive validation requests from said host component.

15. The system of claim 14, wherein said validation requests are comprised of one or more client validation requests.

16. The system of claim 14, wherein said validation requests are comprised of one or more payment validation requests.

17. The system of claim 14, wherein said validation requests are comprised of one or more licensing validation requests.

18. The system of claim 14, wherein said validation requests are comprised of one or more client location validation request.

19. The system of claim 10, wherein said host component is configured to validate the location of said one or more client components.

20. The system of claim 10, wherein said host component is configured to receive client content from at least one of said one or more client components.
